(19) United States
(12) Patent Application Publication
(10) Pub. No.: US 2026/0267923 A1
(43) Pub. Date: Sep. 10, 2026

(54) INFORMATION PROCESSING APPARATUS

(71) Applicant: NEC Corporation, Tokyo (JP)

(72) Inventor: Motoi SUZUKI, Tokyo (JP)

(73) Assignee: NEC Corporation, Tokyo (JP)

(21) Appl. No.: 19/550,434

(22) Filed: Feb. 26, 2026

(30) Foreign Application Priority Data
Mar. 7, 2025 (JP) 2025-036029

(51) Int. Cl. G06F 16/903

(52) U.S. Cl. CPC G06F 16/90335

(57) ABSTRACT

An information processing apparatus according to the present disclosure includes a search unit that searches for a solution for a first optimization problem and a save unit that saves a solution specified based on a search situation of the solution for the first optimization problem, from among the searched solutions. Then, the search unit searches for a solution for a second optimization problem using the saved solution. This configuration enables rapid optimization-oriented decision making through the application of artificial intelligence techniques.

### INCORPORATION OF BASIC APPLICATION

The present invention is based upon and claims the benefit of the priority of Japanese Patent Application No. 2025-036029 filed on Mar. 7, 2025 in Japan, the disclosure of which is incorporated herein in its entirety by reference.

### TECHNICAL FIELD

The present disclosure relates to an information processing apparatus.

### BACKGROUND ART

As a method for solving problems in the real world, a combinatorial optimization problem is set, and a solution is searched for. For example, PTL 1 describes that an optimal solution of a new optimization problem is searched for, using solution information generated by optimizing the combinatorial optimization problem.

PTL 1: Japanese Unexamined Patent Application Publication No. H07-319848A

### SUMMARY

However, with the technique described in PTL 1, in a case where solution information is enormous, it takes time to search for a solution in a new optimization problem. As a result, there is a problem that it is not possible to solve the optimization problem at high speed.

Therefore, one object of the present disclosure is to solve the problem described above that it is not possible to solve an optimization problem at high speed.

An information processing apparatus according to one aspect of the present disclosure has a configuration including
a search unit that searches for a solution for a first optimization problem and
a save unit that saves a solution specified based on a search situation of the solution for the first optimization problem, from among the searched solutions, in which
   the search unit searches for a solution for a second optimization problem using the saved solution.

An information processing method according to one aspect of the present disclosure performed by an information processing apparatus has a configuration including
searching for a solution for a first optimization problem,
saving a solution specified based on a search situation of the solution for the first optimization problem, from among the searched solutions, and
searching for a solution for a second optimization problem using the saved solution.

A program according to one aspect of the present disclosure has a configuration for causing an information processing apparatus to execute processing for
searching for a solution for a first optimization problem,
saving a solution specified based on a search situation of the solution for the first optimization problem, from among the searched solutions, and
searching for a solution for a second optimization problem using the saved solution.

With the above configuration, the present disclosure can solve an optimization problem at high speed.

### BRIEF DESCRIPTION OF THE DRAWINGS

FIG. 1 is a block diagram illustrating an example of a configuration of an information processing apparatus according to the present disclosure;

FIG. 2 is a flowchart illustrating an example of a processing operation of the information processing apparatus according to the present disclosure;

FIG. 3 is a flowchart illustrating an example of the processing operation of the information processing apparatus according to the present disclosure;

FIG. 4 is a diagram illustrating an example of the processing of the information processing apparatus according to the present disclosure;

FIG. 5 is a diagram illustrating an example of the processing of the information processing apparatus according to the present disclosure;

FIG. 6 is a block diagram illustrating an example of a hardware configuration of the information processing apparatus according to the present disclosure;

FIG. 7 is a block diagram illustrating an example of the configuration of the information processing apparatus according to the present disclosure; and

FIG. 8 is a flowchart illustrating an example of the processing operation of the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing apparatus 10 according to the present disclosure is suitable for use in a case of searching for solutions for a plurality of optimization problems. At this time, the plurality of optimization problems is desirably problems similar to each other. For example, the optimization problem is a combinatorial optimization problem, and it is assumed that the optimization problem be solved by a method called simulated annealing, as an example in the present example embodiment. In simulated annealing, at the time of searching for the solution for the optimization problem, an optimal solution is searched, by a method in which the solution always transitions to a neighborhood solution in a case where an evaluation value of the neighborhood solution is good, and the solution stochastically transitions in a case where the evaluation value of the neighborhood solution is bad.

However, the optimization problem to be solved in the present disclosure is not limited to the combinatorial optimization problem and may be any optimization problem. The plurality of optimization problems to be solved is not necessarily limited to the problems similar to each other and may be problems that are not similar to each other.

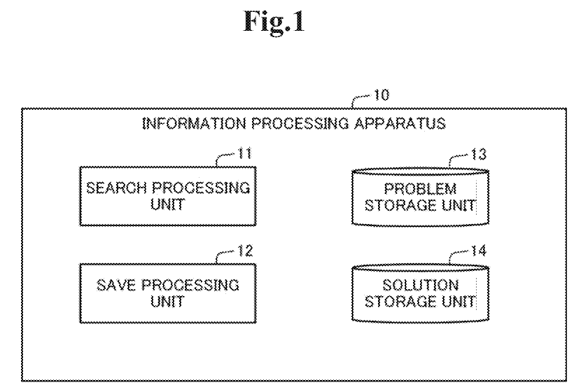

Hereinafter, examples of a configuration and an operation of the information processing apparatus 10 according to the present example embodiment will be described. The information processing apparatus 10 is configured with one or a plurality of information processing apparatuses including arithmetic devices and storage devices. Then, as illustrated in FIG. 1, the information processing apparatus 10 includes a search processing unit 11 and a save processing unit 12. Each of functions of the search processing unit 11 and the save processing unit 12 can be achieved by the arithmetic device executing a program for achieving each function stored in the storage device. The information processing apparatus 10 includes a problem storage unit 13 and a solution storage unit 14, achieved by the storage devices.

The search processing unit 11 (search unit) executes processing for searching for a solution (solution candidate) for a given optimization problem. It is assumed that the optimization problem for which a solution is searched for be stored in the problem storage unit 13 in advance. At this time, it is assumed that the plurality of optimization problems be stored in the problem storage unit 13 and at least a first optimization problem and a second optimization problem be stored.

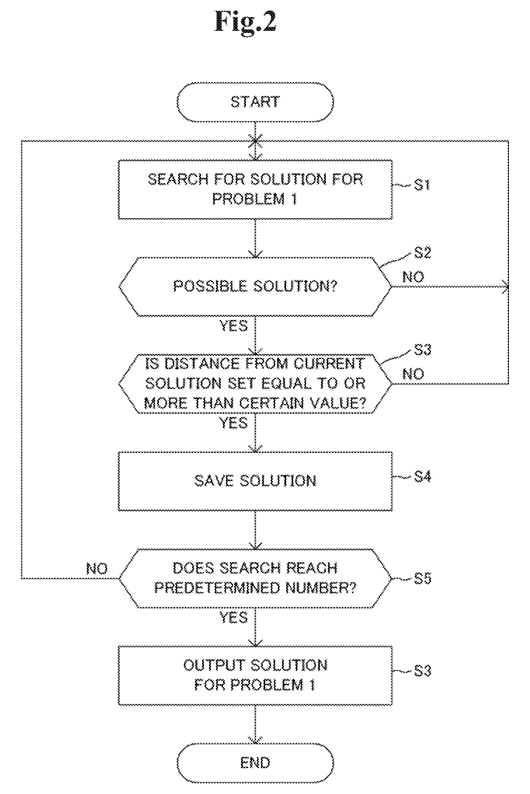

First, the search processing unit 11 reads the first optimization problem and searches for a solution by simulated annealing. At this time, the search processing unit 11 may start to search for the solution without an initial solution and may start to search for the solution from a given initial solution. Then, the search processing unit 11 searches for the solution step by step (step S1 in FIG. 2) and determines whether the solution candidate is a possible solution that satisfies a constraint condition (step S2 in FIG. 2). In a case where the solution candidate is the possible solution (YES in step S2 in FIG. 2), the search processing unit 11 determines whether to save the solution (step S3 in FIG. 2). In a case where the solution candidate is not the possible solution (NO in step S2 in FIG. 2), if the search does not reach a predetermined number (NO in step S5 in FIG. 2), the search processing unit 11 proceeds to the next step and searches for the solution (step S1 in FIG. 2). In a case where the solution search reaches the predetermined number (YES in step S5 in FIG. 2), an optimal solution searched until then is output (step S6 in FIG. 2).

The save processing unit 12 (save unit) specifies a solution to be saved based on a search situation, from among the solutions searched in each step as described above. Specifically, the save processing unit 12 sequentially receives the searched solution, and determines whether the solution meets a preset solution save reference. In the present example embodiment, as the solution save reference, in a case where a similarity between the searched solutions according to a preset reference is low, it is assumed to specify these as the solutions to be saved. As an example, in a case where the save processing unit 12 calculates a distance between a solution or a solution set saved so far and a newly searched solution and determines that these solutions are not similar to each other and specifies these solutions as the solutions to be saved in a case where the distance is equal to or more than a certain value (YES in step S3 in FIG. 2). Then, the save processing unit 12 saves the specified solution in the solution storage unit 14 (step S4 in FIG. 2). As the distance between the solutions calculated by the save processing unit 12, for example, a Hamming distance or a Levenshtein distance may be used.

However, the save processing unit 12 is not necessarily limited to determining whether the solutions are not similar to each other using the distance between the solutions. For example, the save processing unit 12 may extract a preset feature amount from each solution, determine whether the solutions are not similar to each other according to a similarity of the feature amount, and specify the solution to be saved. In this way, the save processing unit 12 may determine whether the solutions are not similar to each other, based on a relationship between the solutions, such as the distance between the solutions or comparison between the feature amounts, and specify the solution to be saved.

In a case where the distance between the newly searched solution and the saved solution is not equal to or more than the certain value and the save processing unit 12 determines that the solutions are similar to each other (NO in step S3 in FIG. 2), the save processing unit 12 does not save the newly searched solution. However, at this time, one of the saved solution and the newly searched solution may be saved, and for example, the saved solution may be deleted from the solution storage unit 14, and the newly searched solution may be stored in the solution storage unit 14. Then, thereafter, the search processing unit 11 checks whether the search reaches the predetermined number, and if the search does not reach the predetermined number (NO in step S5 in FIG. 2), the search processing unit 11 proceeds to the next step and searches for the solution (step S1 in FIG. 2). In a case where the solution search reaches the predetermined number (YES in step S5 in FIG. 2), the optimal solution searched so far is output (step S6 in FIG. 2).

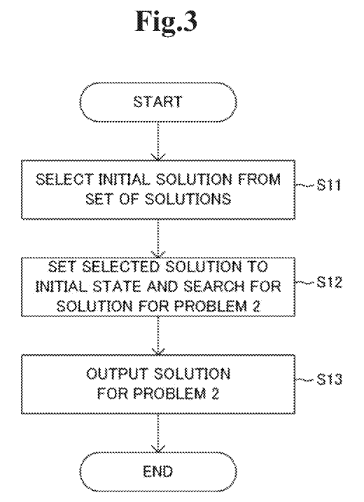

Then, as described above, when the search for the solution for the first optimization problem ends and the optimal solution is output, then, the processing proceeds to search for a solution for the second optimization problem. The search processing unit 11 reads the second optimization problem and searches for the solution by simulated annealing. At this time, the search processing unit 11 searches for the solution for the second optimization problem, using the solution searched in the first optimization problem saved in the solution storage unit 14. For example, the search processing unit 11 may select one or a plurality of solutions from among the saved solutions (step S11 in FIG. 3), and set the selected solution as the initial solution for the second optimization problem and search for the solution (step S12 in FIG. 3). In a case where the plurality of solutions is selected, the solution for the second optimization problem may be searched sequentially using each solution as the initial solution, and the solution for the second optimization problem may be searched in parallel using each of the plurality of initial solutions.

When selecting the solution used for the second optimization problem, among the saved solutions, for example, the search processing unit 11 may select the best solution in the first optimization problem. The search processing unit 11 may select one or a plurality of solutions, based on evaluation according to the preset reference, such as top 1% solutions with good evaluation in the first optimization problem. The search processing unit 11 may not only use the selected solution as the initial solution but also set the selected solution as a solution changed during solution search, and may continue the search from the changed solution.

Then, in a case where the search processing unit 11 proceeds the solution search and the solution search reaches the predetermined number, the search processing unit 11 outputs the optimal solution searched so far (step S13 in FIG. 3). When the search processing unit 11 searches for the solution for the second optimization problem, the save processing unit 12 may save the searched solution in the solution storage unit 14, as described above. In this case, the save processing unit 12 checks whether the solution searched in the second optimization problem is similar to the saved solution, as described above and saves the solution, in a case where the solutions are not similar to each other. The saved solution to be compared as to whether the solution is similar to the searched solution may be all the solutions saved so far, that is, the solutions saved at the time of search in the first optimization problem and the second optimization problem, and may be the solutions saved at the time of search of one of the optimization problems.

As described above, in the present disclosure, the solutions determined to be not similar to each other are saved, among the solutions searched in the first optimization problem, and the search of the second optimization problem is performed using the solutions. As a result, in a case where the second optimization problem has content similar to that of the first optimization problem, a structure of the solution for the second optimization problem is assumed to be similar to the first optimization problem. Therefore, it can be expected to reach a good solution or an optimal solution for the second optimization problem in a short time. In particular, since the solutions saved and used in the second optimization problem are the solutions determined to be not similar to each other, not all of the solutions searched in the first optimization problem are saved. Therefore, it is possible to efficiently search for the solution for the second optimization problem using the saved solution and obtain the solution at high speed.

### Second Example Embodiment

Next, a second example embodiment of the present disclosure will be described with reference to the drawings. The drawings may relate to any example embodiment.

An information processing apparatus 10 according to the present example embodiment has a configuration similar to that of the first example embodiment. In addition, the information processing apparatus 10 has the following configuration. Hereinafter, a configuration different from the above will be mainly described.

In the present example embodiment, a save processing unit 12 (save unit) in the information processing apparatus 10 specifies a solution to be saved among searched solutions, by a method different from the above. Specifically, the save processing unit 12 sequentially receives the searched solution and saves the solution specified based on a search interval between the searched solutions. As an example, in a case where a search step interval or a search time interval between solutions or a solution set saved so far and a newly searched solution is equal to or more than a certain value, the save processing unit 12 specifies the solution as the solution to be saved. In this way, in the present example embodiment, in a case where the search interval between the searched solutions is larger according to a preset reference, it is estimated that these solutions are not similar to each other, and these solutions are specified as the solutions to be saved. Then, the save processing unit 12 saves the specified solution in the solution storage unit 14. The save processing unit 12 may specify the searched solution as the solution to be saved, for each certain search steps or each time when a certain search time elapses, and save the solution.

As described above, in the present disclosure, the solutions are saved that may be determined to be not similar to each other, based on the relationship between the solutions such as the search interval between the solutions. Therefore, all the solutions searched in the first optimization problem are not saved, and it is possible to efficiently search for the solution for the second optimization problem using the saved solution, and it is possible to obtain the solution at high speed.

### Third Example Embodiment

Next, a third example embodiment of the present disclosure will be described with reference to the drawings. The drawings may relate to any example embodiment.

In the present example embodiment, a case where the information processing apparatus 10 described above solves a specific optimization problem will be described. Here, the optimization problem described in the present example embodiment is a constrained combinatorial optimization problem, and as an example, is referred to as a traveling salesman problem. The traveling salesman problem is an optimization problem in which, when distances between cities (points) are given, a traveling route having a minimum movement distance is obtained under a constraint condition that a salesman visits every city once. At this time, in the traveling salesman problem, a “One-hot” constraint, which is a constraint that only one of included variables x is 1, is set as the constraint condition. Then, the constrained combinatorial optimization problem is converted into a quadratic unconstrained binary optimization (QUBO) model that is a formulated model, and the solution is searched by simulated annealing.

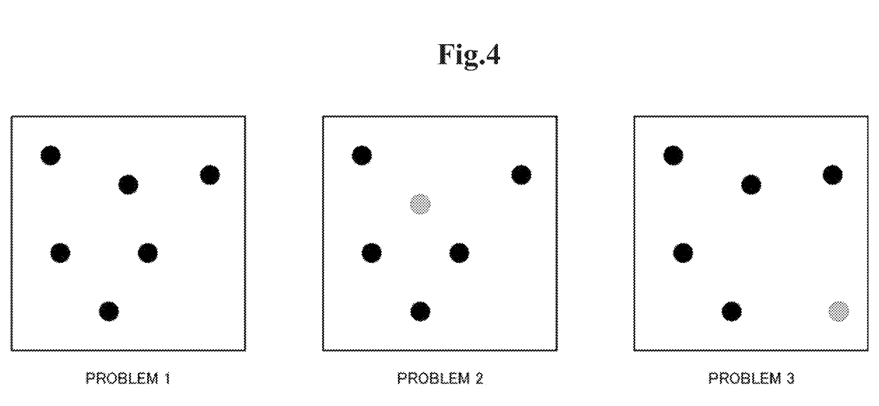

Then, in the present example embodiment, it is assumed that the three optimization problems be set and be sequentially solved. Specifically, as illustrated in FIG. 4, three traveling salesman problems in which each point indicated by a circle is visited once are set, and the points to be visited slightly change in each traveling salesman problem. For example, a gray point changes in problems 2 and 3 with respect to a problem 1, and it is assumed that these three problems be similar to each other. As a case where the points are changed, for example, a case is considered where a substantial distance between the points is changed due to an influence of road conditions (road closure due to constructions, regulations, or the like) or congestions. As another example, a case is considered where visit points of nursing care or transportation differ depending on a date and time.

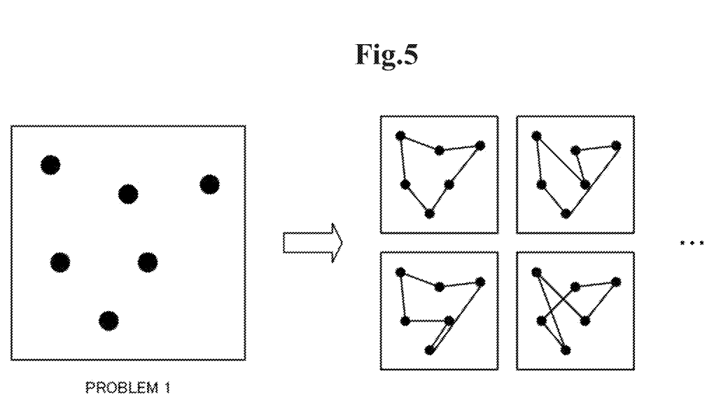

First, for the problem 1, the information processing apparatus 10 searches for a solution in such a way as to visit all the points once and obtain a traveling route with a minimum moving distance. At this time, for example, as illustrated in the right diagram in FIG. 5, it is assumed that the plurality of solutions of the traveling routes be searched. Then, the information processing apparatus 10 specifies a solution to be saved based on the search situation, from among the searched solutions. Specifically, as described above, the information processing apparatus 10 specifies and saves solutions in which a distance is equal to or more than a certain value or solutions of which search intervals are equal to or more than a certain value, as the solutions to be saved. That is, in the traveling salesman problem, routes, which are the solutions, considered to be not similar to each other are saved.

Then, the information processing apparatus 10 solves the problems 2 and 3, using the solution saved in the search for the solution for the problem 1. At this time, the information processing apparatus 10 selects the one or the plurality of solutions from among the saved solutions and solves the problems 2 and 3 using these as initial solutions. In this way, by using the solution searched and saved in the problem 1, it is possible to efficiently search for the solutions for the problems 2 and 3, and it is possible to obtain the solution at high speed. The information processing apparatus 10 may solve the problem 3, after solving the problem 2 and further saving the solution.

Here, in the above description, although the traveling salesman problem has been exemplified as an example of the optimization problem to be solved, a problem having any content may be targeted. For example, a problem for planning a work shift may be targeted. In this case, since monthly work shifts are often similar to each other, it can be said that the problems for monthly planning the work shifts are similar to each other. Therefore, by using the information processing apparatus 10 according to the present disclosure, it is possible to solve the optimization problem at high speed.

### Fourth Example Embodiment

Next, a fourth example embodiment of the present disclosure will be described with reference to the drawings. In the present example embodiment, an outline of the information processing apparatuses and the like described in the above-described example embodiments will be illustrated. The drawings may relate to any example embodiment.

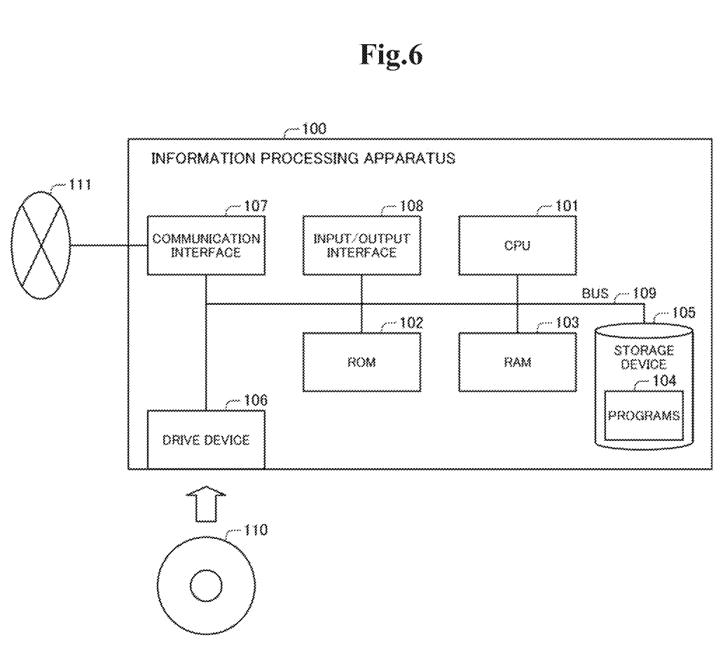

First, a hardware configuration of an information processing apparatus 100 in the present disclosure will be described. The information processing apparatus 100 is constituted by a general information processing apparatus and has the following hardware configuration, as illustrated in FIG. 6, as an example.
A central processing unit (CPU) 101 (arithmetic device)
A read only memory (ROM) 102 (storage device)
A random access memory (RAM) 103 (storage device)
Programs 104 to be loaded into the RAM 103
A storage device 105 that stores the programs 104
A drive device 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 6 illustrates an example of the hardware configuration of the information processing apparatus that is the information processing apparatus 100, and the hardware configuration of the information processing apparatus is not limited to the above-described case. For example, the information processing apparatus may be constituted by a part of the above-described configuration such as not including the drive device 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

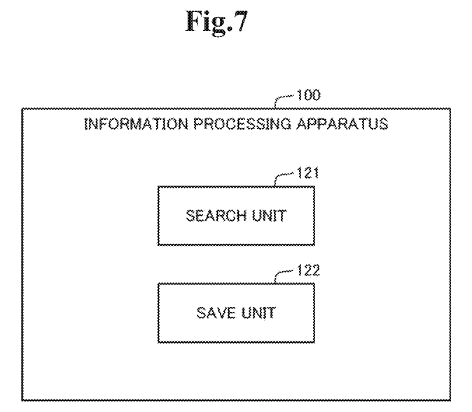

Then, a search unit 121 and a save unit 122 illustrated in FIG. 7 can be constructed and equipped in the information processing apparatus 100 by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the above-described search unit 121 and save unit 122 may be constructed by a dedicated electronic circuit for achieving the means.

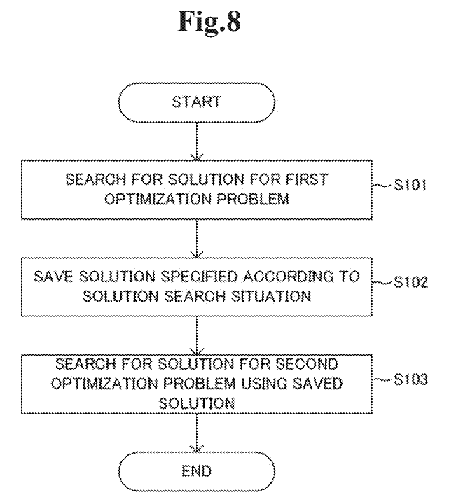

The search unit 121 searches for a solution for a first optimization problem (step S101 in FIG. 8). The save unit 122 saves a solution specified based on a search situation of the solution for the first optimization problem, from among the searched solutions (step S102 in FIG. 8). Then, the search unit 121 further searches for a solution for a second optimization problem using the saved solution (step S103 in FIG. 8).

With the above configuration, the information processing apparatus 100 first searches for the solution for the first optimization problem. At this time, the information processing apparatus 100 saves the solution specified based on the search situation of the solution for the first optimization problem, from among the searched solutions. For example, the information processing apparatus specifies and saves solutions in which a distance is equal to or more than a certain value or solutions of which search intervals are equal to or more than a certain value, as solutions to be saved. Then, the information processing apparatus 100 searches for the solution for the second optimization problem using the saved solution. As a result, in a case where the second optimization problem has content similar to that of the first optimization problem, a structure of the solution for the second optimization problem is assumed to be similar to the first optimization problem. Therefore, it can be expected to reach a good solution or an optimal solution for the second optimization problem in a short time. In addition, since the solutions saved and used in the second optimization problem are solutions determined to be not similar to each other and all the solutions searched in the first optimization problem are not saved, it is possible to efficiently search for the solution for the second optimization problem using the saved solution, and it is possible to obtain the solution at high speed.

At least one or more of the above-described functions of the search unit 121 and the save unit 122 may be executed by an information processing apparatus installed and connected at any place on a network, that is, may be executed on so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, flexible disk, magnetic tape, or hard disk drive), an optical magnetic recording medium (for example, magneto-optical disc), a compact disc-read only memory (CD-ROM), a CD-R, a CD-R/W, and a semiconductor memory (for example, mask ROM, programmable ROM (PROM), erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### Supplementary Note

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following Supplementary Notes.

Some or all of the configurations described in Supplementary Notes 2 to 8 dependent on Supplementary Note 1 described below and the functions according to those configurations can also be dependent on other Supplementary Notes 9 and 10 by a dependency relationship similar to that of Supplementary Notes 2 to 8. Moreover, some or all of the configurations described as the supplementary notes and the functions according to those configurations can be similarly dependent on not only Supplementary Notes 1, 9, and 10, but also various pieces of similar hardware and software, and various types of recording means that record the software, or systems without departing from the above-described example embodiments.

### Supplementary Note 1

An information processing apparatus including:
a search unit configured to search for a solution for a first optimization problem; and
a save unit configured to save a solution specified based on a search situation of the solution for the first optimization problem, from among the searched solutions, in which
   the search unit searches for a solution for a second optimization problem using the saved solution.

### Supplementary Note 2

The information processing apparatus according to supplementary note 1,
in which the save unit saves a solution specified based on a preset relationship between the searched solutions.

### Supplementary Note 3

The information processing apparatus according to supplementary note 2, in which
the save unit saves a solution specified by a low similarity between the searched solutions according to a preset reference.

### Supplementary Note 4

The information processing apparatus according to supplementary note 1, in which
the save unit saves a solution specified based on a search interval between the searched solutions.

### Supplementary Note 5

The information processing apparatus according to supplementary note 4, in which
the save unit saves a solution specified by a larger search interval between the searched solutions according to a preset reference.

### Supplementary Note 6

The information processing apparatus according to supplementary note 1, in which
the save unit saves a solution specified by the searched solution satisfying a constraint set for the first optimization problem.

### Supplementary Note 7

The information processing apparatus according to supplementary note 1,
in which the search unit searches for the solution for the second optimization problem using a solution selected based on evaluation according to a preset reference, from among the saved solutions.

### Supplementary Note 8

The information processing apparatus according to supplementary note 7,
in which the search unit searches for the solutions for the second optimization problem in parallel, using a plurality of the solutions selected based on the evaluation from among the saved solutions.

### Supplementary Note 9

An information processing method performed by an information processing apparatus, the method including:
searching for a solution for a first optimization problem;
saving a solution specified based on a search situation of the solution for the first optimization problem, from among the searched solutions; and
searching for a solution for a second optimization problem using the saved solution.

### Supplementary Note 10

A program for causing an information processing apparatus to execute processing for:
searching for a solution for a first optimization problem;
saving a solution specified based on a search situation of the solution for the first optimization problem, from among the searched solutions; and
searching for a solution for a second optimization problem using the saved solution.

### REFERENCE SIGNS LIST

10 information processing apparatus

11 search processing unit

12 save processing unit

13 problem storage unit

14 solution storage unit

100 information processing apparatus

101 CPU

102 ROM

103 RAM

104 programs

105 storage device

106 drive device

107 communication interface

108 input/output interface

109 bus

110 storage medium

111 communication network

121 search unit

122 save unit

1. An information processing apparatus comprising:
at least one memory configured to store processing instructions; and
at least one processor configured to execute the processing instructions to:
search for a solution for a first optimization problem;
save a solution specified based on a search situation of the solution for the first optimization problem, from among the searched solutions; and
further search for a solution for a second optimization problem using the saved solution.

2. The information processing apparatus according to claim 1, wherein
the at least one processor is configured to execute the processing instructions to save a solution specified based on a preset relationship between the searched solutions.

3. The information processing apparatus according to claim 2, wherein
the at least one processor is configured to execute the processing instructions to save a solution specified by a low similarity between the searched solutions according to a preset reference.

4. The information processing apparatus according to claim 1, wherein
the at least one processor is configured to execute the processing instructions to save a solution specified based on a search interval between the searched solutions.

5. The information processing apparatus according to claim 4, wherein
the at least one processor is configured to execute the processing instructions to save a solution specified by a larger search interval between the searched solutions according to a preset reference.

6. The information processing apparatus according to claim 1, wherein
the at least one processor is configured to execute the processing instructions to save a solution specified by the searched solution satisfying a constraint set for the first optimization problem.

7. The information processing apparatus according to claim 1, wherein
the at least one processor is configured to execute the processing instructions to search for the solution for the second optimization problem using a solution selected based on evaluation according to a preset reference, from among the saved solutions.

8. The information processing apparatus according to claim 7, wherein
the at least one processor is configured to execute the processing instructions to search for the solutions for the second optimization problem in parallel, using a plurality of the solutions selected based on the evaluation from among the saved solutions.

9. An information processing method performed by an information processing apparatus, the method comprising:
searching for a solution for a first optimization problem;
saving a solution specified based on a search situation of the solution for the first optimization problem, from among the searched solutions; and
searching for a solution for a second optimization problem using the saved solution.

10. The information processing method according to claim 9, wherein
the information processing apparatus
saves a solution specified based on a preset relationship between the searched solutions.

11. The information processing method according to claim 10, wherein
the information processing apparatus
saves a solution specified by a low similarity between the searched solutions according to a preset reference.

12. The information processing method according to claim 9, wherein
the information processing apparatus
saves a solution specified based on a search interval between the searched solutions.

13. The information processing method according to claim 12, wherein
the information processing apparatus
saves a solution specified by a larger search interval between the searched solutions according to a preset reference.

14. The information processing method according to claim 9, wherein
the information processing apparatus
saves a solution specified by the searched solution satisfying a constraint set for the first optimization problem.

15. The information processing method according to claim 9, wherein
the information processing apparatus
searches for the solution for the second optimization problem using a solution selected based on evaluation according to a preset reference, from among the saved solutions.

16. The information processing method according to claim 15, wherein
the information processing apparatus
searches for the solutions for the second optimization problem in parallel, using a plurality of the solutions selected based on the evaluation from among the saved solutions.

17. A non-transitory computer-readable storage medium storing a program for causing an information processing apparatus to execute processing for:
searching for a solution for a first optimization problem;
saving a solution specified based on a search situation of the solution for the first optimization problem, from among the searched solutions; and
searching for a solution for a second optimization problem using the saved solution.
